(19) United States
(12) Patent Application Publication
(10) Pub. No.: US 2026/0169745 A1
(43) Pub. Date: Jun. 18, 2026

(54) DEAD PRODUCER ELIMINATION

(71) Applicants: Roger Gramunt, Portland, OR (US); Freddy Torres, Portland, OR (US); Patrick Lowry, Highlands Ranch, CO (US); Bryan Pogor, Round Rock, TX (US); Brent Bean, Provo, UT (US); Alexey Suprun, Beaverton, OR (US); Priyank Deshpande, Redwood City, CA (US); Michael Thomson, Hutto, TX (US); William Griffin, Hillsboro, OR (US)

(72) Inventors: Roger Gramunt, Portland, OR (US); Freddy Torres, Portland, OR (US); Patrick Lowry, Highlands Ranch, CO (US); Bryan Pogor, Round Rock, TX (US); Brent Bean, Provo, UT (US); Alexey Suprun, Beaverton, OR (US); Priyank Deshpande, Redwood City, CA (US); Michael Thomson, Hutto, TX (US); William Griffin, Hillsboro, OR (US)

(21) Appl. No.: 18/986,363

(22) Filed: Dec. 18, 2024

(51) Int. Cl. G06F 9/30; G06F 7/57

(52) U.S. Cl. CPC G06F 9/30181; G06F 7/57

(57) ABSTRACT

Techniques for dead producer elimination are described. In an embodiment, an apparatus includes micro-operation (uop) fusion circuitry to analyze a line of uops to find a producer uop and a consumer uop meeting fusibility criteria and to morph the consumer uop into a fused uop, wherein the line of uops includes a number of uops corresponding to a maximum number of uops that can be allocated in a single cycle; dead producer elimination (DPE) circuitry to determine that DPE conditions are satisfied; and an arithmetic-logic unit to execute the fused uop without the producer uop having been executed.

### BACKGROUND

Instruction fusion is a technique that may be used by processors and processor cores in computers and other information processing systems. For example, the microarchitecture of a processor core may provide for two architectural instructions to be fused together such that they are executed, from a performance point of view, as if they were a single instruction.

### BRIEF DESCRIPTION OF DRAWINGS

Various examples in accordance with the present disclosure will be described with reference to the drawings, in which:

FIG. 1 illustrates an apparatus for dead producer elimination according to an embodiment.

FIG. 2A shows an example of code to illustrate per allocation cycle micro-operation fusion according to an embodiment.

FIG. 2B shows a dependency graph without per allocation cycle micro-operation fusion.

FIG. 2C shows a dependency graph with per allocation cycle micro-operation fusion according to an embodiment.

FIG. 2D shows an example of code and micro-operation processing flow to illustrate dead producer elimination according to an embodiment.

FIG. 3 illustrates a method for dead producer elimination according to an embodiment.

FIG. 4 illustrates an example computing system according to an embodiment.

FIG. 5 illustrates a block diagram of an example processor and/or System on a Chip (SoC) that may have one or more cores and an integrated memory controller according to an embodiment.

FIG. 6A is a block diagram illustrating both an example in-order pipeline and an example register renaming, out-of-order issue/execution pipeline according to an embodiment.

FIG. 6B is a block diagram illustrating both an example in-order architecture core and an example register renaming, out-of-order issue/execution architecture core to be included in a processor according to an embodiment.

FIG. 7 illustrates examples of execution unit(s) circuitry according to an embodiment.

FIG. 8 illustrates the use of a software instruction converter to convert binary instructions in a source instruction set architecture to binary instructions in a target instruction set architecture according to an embodiment.

### DETAILED DESCRIPTION

The present disclosure relates to methods, apparatus, systems, and non-transitory computer-readable storage media for dead producer elimination. According to some examples, an apparatus includes micro-operation (uop) fusion circuitry to analyze a line of uops to find a producer uop and a consumer uop meeting fusibility criteria and to morph the consumer uop into a fused uop (which may be referred to as a producer+consumer uop, a fused_producer_consumer uop, a fused uop, etc.), wherein the line of uops includes a number of uops corresponding to a maximum number of uops that can be allocated in a single cycle; dead producer elimination (DPE) circuitry to determine that DPE conditions are satisfied; and an arithmetic-logic unit to execute the fused uop without the producer uop having been executed.

Embodiments may provide improved performance for code with chains of dependent arithmetic-logic unit (ALU) instructions in the critical path. Embodiments may include a feature supported by or implemented in a system, processor, etc. referred to as micro-operation fusion, micro-op fusion, uop fusion, etc., in which a producer operation and a consumer operation (together, a producer-consumer pair) may be fused together and executed as a single operation (e.g., with lower latency). In embodiments, the opcode of the consumer operation may be changed and the new opcode may be executed in a special ALU, resulting in a rearranged dependency graph with a shorter critical path. Additionally, embodiments may allow skipping the execution of the producer uop if certain conditions are met, which may be referred to as dead producer elimination (DPE).

As mentioned in the background section, the microarchitecture of a processor core may provide for two architectural instructions to be fused together such that they are executed, from a performance point of view, as if they were a single instruction. For example, two consecutive architectural instructions may be decoded into a single micro-operation (uop). However, performance gains from such techniques might limited in that the techniques might only work for two consecutive instructions, two instructions decoded in the same cycle, two instructions having a single register (or flags) output, etc. and/or might involve a special protocol for exceptions to be taken between the fused instructions.

Therefore, a uop fusion capability that may be provided by embodiments may be desired. For example, embodiments may provide for fusion of non-adjacent producer-consumer pairs; for producer and consumer uops to write to different registers; for a producer uop to be fused with more than one consumer uop; for exceptions, nukes, and clears to be taken between the producer-consumer pairs without special handling; and/or for elimination of the producer uop. In embodiments, DPE may provide performance benefits by lowering reservation station and ALU execution ports pressure and/or power saving effects since reservation station issue, execution, and register writeback steps may be skipped.

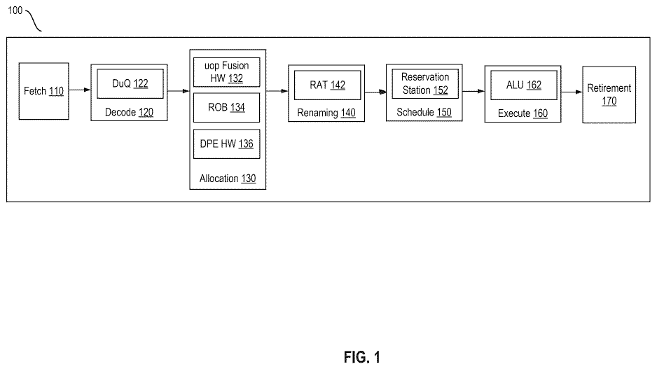

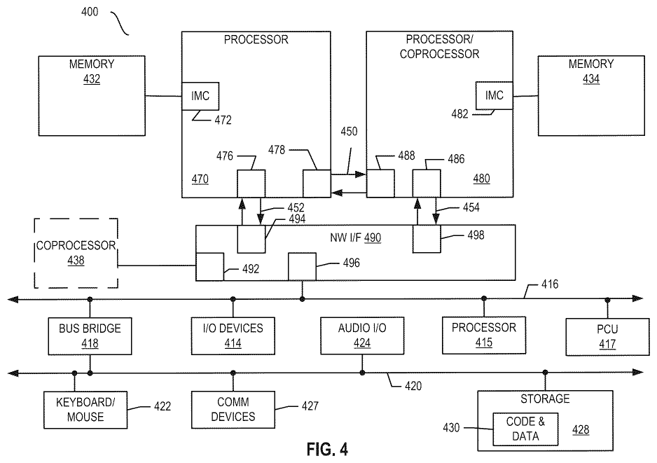

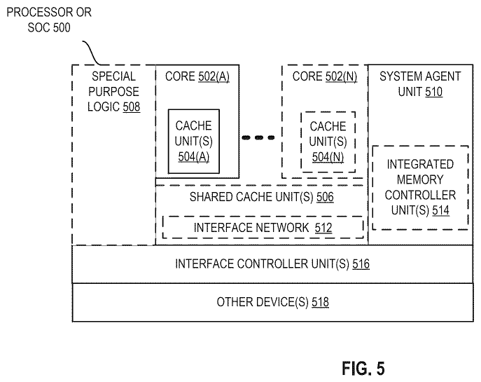

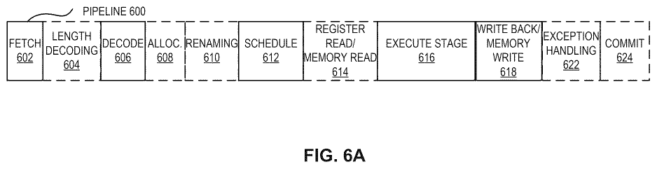

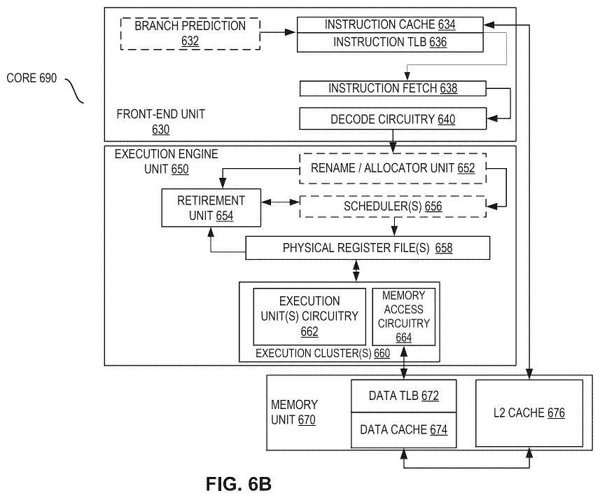

For example, FIG. 1 illustrates an apparatus 100 according to an embodiment. Apparatus 100 represents a simplified (for ease of illustration) version of an instruction processing pipeline that may be implemented in a processor, processor core, execution core, etc. which may be any type of processor/core, including a general-purpose microprocessor/core, such as a processor/core in the Intel® Core® Processor Family or other processor family from Intel® Corporation or another company, a special purpose processor or microcontroller, or any other device or component in an information processing system in which an embodiment may be implemented. For example, apparatus 100 may be implemented in any of processors 470, 480, or 415 in FIG. 4, processor or system-on-a-chip (SoC) 500 or one of cores 502A to 502N in FIG. 5, and/or core 690 in FIG. 6B, each as described below.

As shown in FIG. 1, apparatus 100 includes circuitry, logic gates, structures, hardware, etc. arranged into the following pipeline stages (which may represent or correspond to, in whole or in part, fetch stage 602, decode stage 606, allocation stage 608, renaming stage 610, schedule stage 612, execute stage 616, and commit stage 624, respectively, of pipeline 600 in FIG. 6A): fetch stage 110, decode stage 120, allocation stage 130, renaming stage 140, schedule stage 150, execute stage 160, and retirement stage 170. The pipeline stages are shown in FIG. 1 as an example and each may represent any number of stages that may or may not be rearranged and/or overlap with any other stages shown or not shown. For example, allocation stage 130, renaming stage 140, and/or any stage within either or both may overlap and/or be combined into one or more allocation and renaming stages. Furthermore, any circuitry, logic gates, structures, hardware, etc. shown within a stage in FIG. 1 may be implemented, partially or wholly, within a different stage.

In decode stage 120 instructions (e.g., architectural instructions according to an instruction set architecture (ISA) of a hardware processor) fetched (e.g., from memory) in fetch stage 110 are decoded into uops to be stored in a decoded uop queue, buffer, cache, etc. (e.g., DuQ 122).

In allocation stage 130, a line of uops to be allocated in a single cycle (e.g., the number of uops may differ based on the maximum number (e.g., 20) that may be allocated according to the microarchitecture, based on the number ready for allocation, etc.) may be analyzed (e.g., by uop fusion hardware (HW) 132) to look for pairs of dependent uops (a producer and a consumer) that are no more than a maximum distance apart (e.g., a number N of reorder buffer (ROB 134) entries; in an embodiment N=8 but in other embodiments could be as high as an allocation line size (e.g., 20)).

The analysis may be based on fusibility criteria, such as:
The microarchitecture includes an ALU that can execute the fused operation (e.g., a three input adder, logical-logical, logical-add, add-logical, shift-add, shift-logical, add-load, add-store, logical-shift).
The number of sources of the potential fused uop does not exceed the limit of sources the reservation stations and ALU supports (e.g., three).
Sometimes a consumer uop has more than one producer uop in the search window (N). When this happens, fusion may be performed with the closest producer (this heuristic may be expected to result in the best performance).

If a pair meeting the fusibility criteria is found, the consumer opcode is replaced with or morphed into a new uop opcode (e.g., a producer+consumer uop opcode) and if necessary to remove any register dependency with the consumer uop, the sources of the operations are changed. For example, the renamed source(s) from the producer uop is copied into the consumer uop, and the intermediate source (the one that links the producer uop with the consumer uop) is eliminated, which may be performed in connection with register renaming, using a register alias table (e.g., RAT 142), in renaming stage 140.

Furthermore, if certain criteria for DPE are met, the producer uop may be marked to be eliminated, in which case it will not get written into the reservation station (e.g., reservation station 152 in schedule stage 150), it will not be sent to execute in any ALU (e.g., ALU 162 in execute stage 160), and it will not write back any result into a register file. However, eliminated uops will still be allocated a ROB entry (e.g., in ROB 134) and eventually retire at the same time (atomically) as the consumer uop. In other words, eliminated producer uops are considered done after they complete allocation (e.g., in allocation stage 130) and renaming (e.g., in renaming stage 140).

In embodiments, DPE is possible (e.g., in allocation stage 130) when the producer uop and the consumer uop are adjacent and it can be proven that the result of the producer uop will not be needed.

In embodiments, apparatus 100 includes hardware (e.g., DPE HW 136 in allocation stage 130) to determine if the following conditions are satisfied and, if so, perform DPE.
A producer and a consumer uop have been determined to be fusible and have been paired (e.g., by uop fusion HW 132).
The producer uop and the consumer uop are allocating on same allocation line (e.g., in the same cycle).
The producer uop and consumer uop are within a distance of N−1 ROB entries, where N is the number uops that can atomically retire in the apparatus.
The producer uop and the consumer uop either write the same destination register or the consumer uop does not have a destination.
If the producer uop writes a register, there is only one consumer of that value and it is the consumer uop of the uop fusion pair.
The ROB entry of the producer uop allows clears (typically this means it is the first micro-op of an instruction).
There is only one DPE uop in a group of N ROB entries (atomic retire group).
None of the uops in the atomic group are an execute_at_retirement type of uop.

If the hardware determines that these conditions are met, the producer uop (the oldest of the pair) may be considered a dead producer and may be eliminated, i.e., the producer uop will not be sent to the reservation stations or the ALU ports for execution, and it will be marked as “ready” for retirement (e.g., in the ROB ready bits of the corresponding ROB entry). The eliminated uop will still occupy a ROB entry but it will retire atomically with the second uop (the fused_producer_consumer uop). This means that either both ROB slots retire together or neither retires. The producer (DPE) uop will be the first uop in the atomic retirement group of the N ROB entries that includes the producer uop and the fused_producer_consumer uop.

In FIG. 1, uop fusion hardware 132 may represent circuitry, multiplexers, logic, wiring, etc. to perform the determinations, opcode morphing, source stitching, etc. described in the descriptions of uop fusion, and DPE hardware 136 may represents circuitry, multiplexers, logic, wiring, etc. to perform the determinations, control operations, etc. described in the descriptions of DPE. In embodiments, uop fusion hardware 132 and DPE hardware 136 may share any portion of their hardware.

In schedule stage 150, the fused uop is scheduled (e.g., in reservation station 152) for execution station in a special ALU (e.g., ALU 162) capable of executing the type of the fused operation (e.g., add-add, logical-add, shift-add) with a latency lower than if the producer and consumer operations had been executed individually back to back (e.g., one cycle instead of two cycles).

In execute stage 160, the special ALU (e.g., ALU 162) executes the fused uop.

In retirement stage 170, the producer uop and the fused uop are retired atomically (together), for example by circuitry in retirement unit 654.

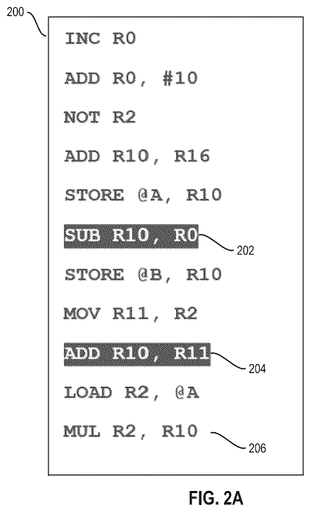

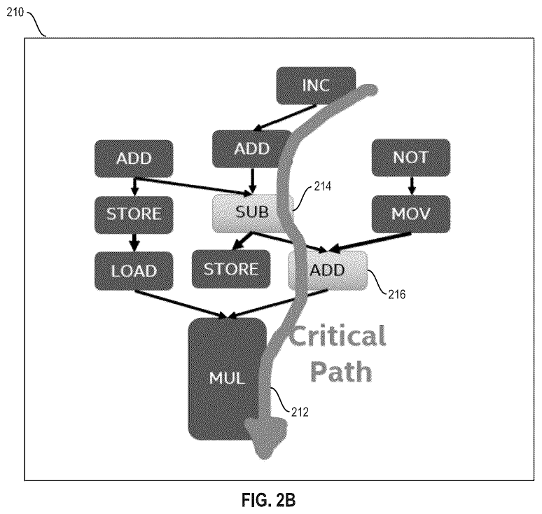

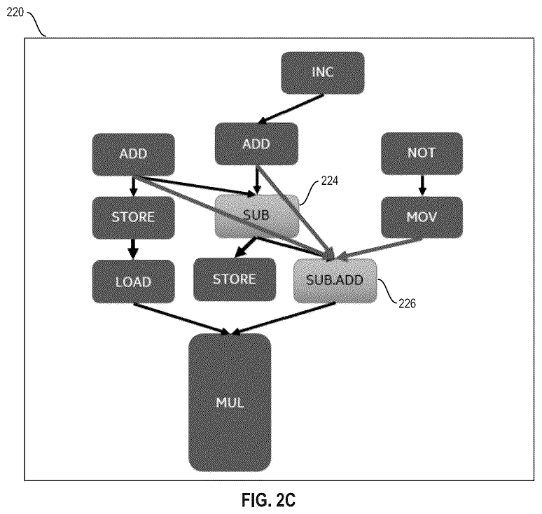

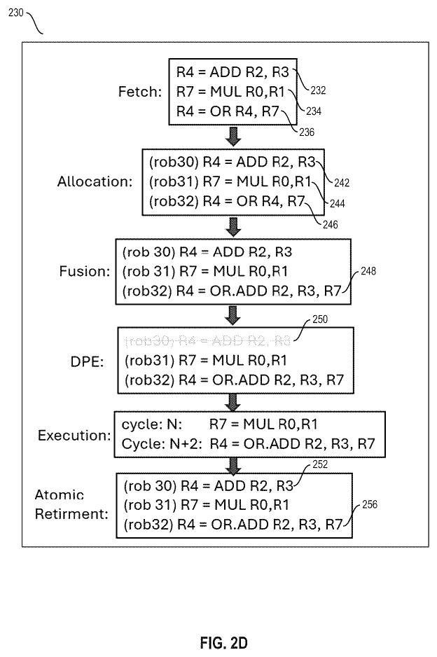

FIG. 2A shows an example of code 200 to illustrate per allocation cycle micro-operation fusion according to an embodiment. Code 200 includes instructions having an opcode (e.g., SUB) that may be decoded into a uop, a destination or source/destination (e.g., a register or memory location (e.g., @ A)), and, in some cases, a source (e.g., a register or memory location (e.g., @ A)). For example, instruction 202 (highlighted in red) has an opcode (SUB), a source/destination (register R10), and a source (register R0), and instruction 204 (also highlighted in red) has an opcode (ADD), a source/destination (register R10), and a source (register R11). The instructions shown in FIG. 2A may represent a line of uops for which allocation is to be performed in a single clock cycle. Although instructions 202 and 204 both write to the same register (R10), it is not required for embodiments to be implemented as such (i.e., they could write to two different registers, e.g., instruction 204 could be ADD R11, R10 and instruction 206 could be MUL R2, R11).

FIG. 2B shows a dependency graph 210 based on execution on a processor without per allocation cycle micro-operation fusion. Critical path 212 is five uops long (including SUB uop 214 corresponding to instruction 202 and ADD uop 216 corresponding to instruction 204) and will take six cycles to execute, based on the following latencies per uop:

$$INC ( 1 cycle ) + ADD ( 1 cycle ) + SUB ( 1 cycle ) + ADD ( 1 cycle ) + MUL ( 2 cycles )$$

FIG. 2C shows a dependency graph 220 based on execution on a processor with per allocation cycle micro-operation fusion according to an embodiment. According to embodiments, the SUB and ADD uops decoded from instructions 202 and 204 are fused into a single SUB.ADD uop 226 resulting in a rearranged dependency graph with a shorter critical path.

For example, the fusion may be performed by uop fusion hardware 132 after analyzing the code and determining that the fusibility criteria is met. As a result, the critical path is four operations long and will take five cycles long to execute, based on the following latencies per operation:

$$INC ( 1 cycle ) + ADD ( 1 cycle ) + SUB . ADD ( 1 cycle ) + MUL ( 2 cycles )$$

Note that although the original consumer uop (e.g., ADD) is changed to a producer+consumer uop (SUB.ADD uop 226), the producer uop (e.g., SUB uop 224) might not be eliminated or altered. It may be left unmodified to execute for reasons that may include:
There could be exceptions/mispredicts that take place after the producer uop but before the consumer uop. In those cases, the apparatus will have to clear and recover at a valid architectural intermediate state. Keeping the unmodified producer uop makes this process seamless. It also allows fusing of a producer load uop and a consumer op (e.g., an arithmetic or logical operation) into a load-op uop, with no special handling for the memory access operation.
There might be other uops that need the result of the producer uop and that are not going to be fused.

Therefore, the producer uop might not be eliminated (e.g., in FIG. 2C, SUB uop 224 is not eliminated because its result is to be stored). However, in an embodiment including DPE, a producer uop may be eliminated as described above.

For example, FIG. 2D shows code and uop processing flow 230 to illustrate dead producer elimination according to an embodiment. Flow 230 includes instructions (add instruction 232, multiply instruction 234, and logical ‘or’ instruction 236), each having an opcode (e.g., ADD, MUL, OR) that may be decoded into a uop (ADD 242, MUL 244, and OR 246, respectively). The instruction also have a destination (e.g., register R4, register R7) and one or more sources (e.g., register R2, register R3, register R0, register R1, register R4, register R7). In some cases, a register may be a source and destination for the same instruction (e.g., register R4 for instruction 236).

The instructions shown in FIG. 2D are decoded into uops that are all in the same line of uops (e.g., for which allocation is to be performed in the same single clock cycle).

According to embodiments, a producer uop (ADD uop 242) and a consumer uop (OR uop 246) decoded from instructions 232 and 236, respectively, are fused into a single fused_producer_consumer uop (OR.ADD uop 248). For example, the fusion may be performed by uop fusion hardware 132 after analyzing the code and determining that the fusibility criteria is met.

According to embodiments, the producer uop (ADD uop 242) is eliminated, as represented by 250. For example, DPE may be performed by DPE hardware 136 by analyzing the code and/or uops and determining that the DPE conditions (as described above) are satisfied (e.g., the producer ADD uop 242 and consumer OR uop 246 write to the same register (R4), consumer OR uop 246 is the only consumer of the result of producer ADD uop 242, the producer ADD uop 242 and consumer OR uop 246 pair are fused into OR.ADD uop 248, etc.).

As a result of the elimination of producer ADD uop 242, it is not scheduled or executed. However, it still occupies a ROB entry (rob30), for which the ready bits are marked “ready” such that it is retired atomically (together) with fused_producer_consumer OR.ADD uop 248 (as represented by 252 and 256).

In embodiments, atomic retirement may be performed according to a protocol that may be referred to as a “clear-refetch” protocol. For example, a situation in which a DPE uop (i.e., a producer uop that has been eliminated) retires and then an ROB clearing event (e.g., nuke, clear) is taken before the corresponding fused_producer_consumer uop retires must be avoided. Otherwise, it would leave the apparatus with incorrect architectural state because the DPE uop was eliminated and did not execute.

To prevent this situation, embodiments may include support for atomic retirement of N ROB entries, meaning that the machine will retire the N uops together once all of them are ready to retire.

If the first uop (e.g., the DPE uop) of the atomic group attempts to trap or any other uop of the group faults, an atomic retirement cannot be performed since a nuke/clear would need to be taken in between (e.g., between retirement of the DPE uop and the fused uop). For this case, embodiments may include a protocol according to which such events are detected, in response to which retirement hardware (e.g., circuitry in retirement unit 654) waits until the DPE uop is the next uop to retire and then generates a pipeline clear (immediately before the DPE uop), thus triggering refetch of the same instructions (e.g., including the instructions corresponding to the producer-consumer pair) by the apparatus. But this second time around, the fusion and DPE hardware will be disabled for the first allocation line. So, both the first (e.g., producer) and second (e.g., consumer) uops will execute unmodified and no atomic retirement will be needed, thus allowing the nuke/clear to be taken in between the uops if needed.

In embodiments, this clear-refetch protocol is also invoked in cases in which some instruction in the atomic group is dynamically promoted to execute-at-retirement (e.g., an uncacheable (UC) memory access).

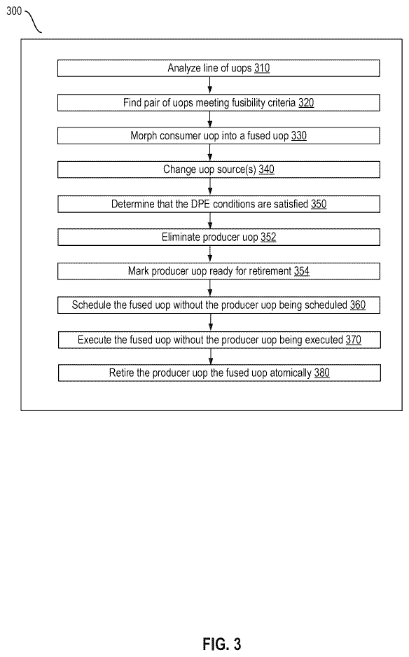

FIG. 3 illustrates a method 300 for dead producer elimination according to an embodiment. In 310 of method 300, a line of uops to be allocated in a single cycle is analyzed to look for a pair of dependent uops (a producer and a consumer) that are no more than a maximum distance apart (as described above). In 320, a pair meeting the fusibility criteria is found. In 330, the consumer opcode is morphed into a new uop opcode (e.g., a producer+consumer uop opcode). In 340, the source(s) are changed as described above (e.g., and as shown in FIG. 2C).

In 350, it is determined (e.g., by DPE HW 136) that the producer and consumer uop pair satisfies the conditions for DPE as described, for example, above. In 352, the producer uop is eliminated (and may be referred to as a dead producer uop). As a result of the elimination of the producer uop, it will not be scheduled or executed.

In 354, the producer uop is marked ready for retirement (e.g., by marking ready bits in a ROB entry for the dead producer uop as “ready”), such that it will be retired atomically (together) with the fused_producer_consumer uop.

In 360, despite the elimination of the producer uop (including that the producer uop is not scheduled), the fused uop is scheduled for execution in a special ALU capable of executing the type of the fused operation with a latency lower than if the producer and consumer operations had been executed individually back to back (e.g., one cycle instead of two cycles).

In 370, despite the elimination of the producer uop (including that the producer uop is not executed), the special ALU executes the fused uop.

In 380, the dead producer uop and the fused_producer_consumer uop are retired atomically (together).

### Example Apparatuses, Methods, Etc.

According to some examples, an apparatus (e.g., a hardware processor, processor core, execution core, etc.) includes micro-operation (uop) fusion circuitry to analyze a line of uops to find a producer uop and a consumer uop meeting fusibility criteria and to morph the consumer uop into a fused uop, wherein the line of uops includes a number of uops corresponding to a maximum number of uops that can be allocated in a single cycle; dead producer elimination (DPE) circuitry to determine that DPE conditions are satisfied; and an arithmetic-logic unit to execute the fused uop without the producer uop having been executed.

Any such examples may include any or any combination of the following aspects. The apparatus also includes a reorder buffer (ROB) in which a ROB entry is allocated for the producer uop. The DPE circuitry is also to indicate, in the ROB entry, that the producer uop is ready for retirement. The apparatus also includes a reservation station to schedule the fused uop without scheduling the producer uop. The apparatus also includes retirement circuitry to retire the producer uop and the fused uop together. The producer uop and the fused uop are in a group of uops to be retired atomically and wherein in response to a fault occurring within the group of uops, the retirement circuitry is to wait until the producer uop is next to retire, generate a pipeline clear, and disable the DPE circuitry. The DPE conditions include that the consumer uop has no destination or that the consumer uop writes to a same register as the producer uop. The DPE conditions include that the consumer uop is the only consumer of a result of the producer uop.

According to some examples, a method includes analyzing a line of uops to find a producer uop and a consumer uop meeting fusibility criteria, wherein the line of uops includes a number of uops corresponding to maximum number of uops that can be allocated in a single cycle; morphing the consumer uop into a fused uop; determining that dead producer elimination (DPE) conditions are met; and executing the fused uop without the producer uop having been executed.

Any such examples may include any or any combination of the following aspects. The method also includes allocating an reorder buffer (ROB) entry for the producer uop. The method also includes indicating, in the ROB entry, that the producer uop is ready for retirement. The method also includes scheduling the fused uop in a reservation station without scheduling the producer uop. The method also includes retiring the producer uop and the fused uop together. The producer uop and the fused uop are in a group of uops to be retired atomically, and the method also includes, in response to a fault occurring within the group of uops, waiting until the producer uop is next to retire; generating a pipeline clear; and disabling DPE circuitry. The DPE conditions include that the consumer uop has no destination or that the consumer uop writes to a same register as the producer uop. The DPE conditions include that the consumer uop is the only consumer of a result of the producer uop.

According to some examples, a non-transitory machine-readable medium storing instructions which, when decoded by a machine, causes the machine to perform a method comprising analyzing a line of uops to find a producer uop and a consumer uop meeting fusibility criteria, wherein the line of uops includes a number of uops corresponding to maximum number of uops that can be allocated in a single cycle; morphing the consumer uop into a fused uop; determining that dead producer elimination (DPE) conditions are met; and executing the fused uop without the producer uop having been executed.

Any such examples may include any or any combination of the following aspects. The method also includes allocating an reorder buffer (ROB) entry for the producer uop; and indicating, in the ROB entry, that the producer uop is ready for retirement. The method also includes scheduling the fused uop in a reservation station without scheduling the producer uop. The method also includes retiring the producer uop and the fused uop together.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when decoded and/or executed by a machine causes the machine to perform any method or portion of a method disclosed herein. Embodiments may include any details, features, etc. or combinations of details, features, etc. described in this specification.

### Example Computer Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, the first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high throughput many integrated cores (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller unit circuitry 516 couples the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

Example Core Architectures—In-order and out-of-order core block diagram.

FIG. 6A is a block diagram illustrating both an example in-order pipeline and an example register renaming, out-of-order issue/execution pipeline according to examples. FIG. 6B is a block diagram illustrating both an example in-order architecture core and an example register renaming, out-of-order issue/execution architecture core to be included in a processor according to examples. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 6B may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 7) various circuitry may be involved in the exception handling stage 622; and 8) the retirement unit circuitry 654 and the physical register file(s) circuitry 658 perform the commit stage 624.

FIG. 6B shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster- and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

### Example Execution Unit(s) Circuitry.

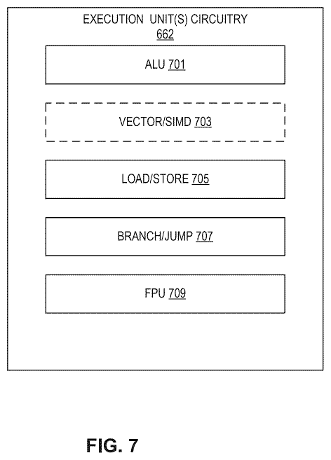

FIG. 7 illustrates examples of execution unit(s) circuitry, such as execution unit(s) circuitry 662 of FIG. 6B. As illustrated, execution unit(s) circuitry 662 may include one or more ALU circuits 701, optional vector/single instruction multiple data (SIMD) circuits 703, load/store circuits 705, branch/jump circuits 707, and/or Floating-point unit (FPU) circuits 709. ALU circuits 701 perform integer arithmetic and/or Boolean operations. Vector/SIMD circuits 703 perform vector/SIMD operations on packed data (such as SIMD/vector registers). Load/store circuits 705 execute load and store instructions to load data from memory into registers or store from registers to memory. Load/store circuits 705 may also generate addresses. Branch/jump circuits 707 cause a branch or jump to a memory address depending on the instruction. FPU circuits 709 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

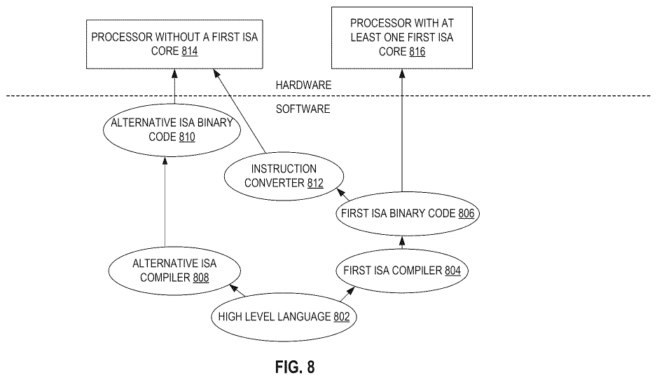

FIG. 8 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 8 shows a program in a high-level language 802 may be compiled using a first ISA compiler 804 to generate first ISA binary code 806 that may be natively executed by a processor with at least one first ISA core 816. The processor with at least one first ISA core 816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 804 represents a compiler that is operable to generate first ISA binary code 806 (e.g., object code) that can, with or without additional linkage processing, be executed on the processor with at least one first ISA core 816. Similarly, FIG. 8 shows the program in the high-level language 802 may be compiled using an alternative ISA compiler 808 to generate alternative ISA binary code 810 that may be natively executed by a processor without a first ISA core 814. The instruction converter 812 is used to convert the first ISA binary code 806 into code that may be natively executed by the processor without a first ISA core 814. This converted code is not necessarily to be the same as the alternative ISA binary code 810; however, the converted code will accomplish the general operation and be made up of instructions from the alternative ISA. Thus, the instruction converter 812 represents software, firmware, hardware, or a combination thereof that, through emulation, simulation, or any other process, allows a processor or other electronic device that does not have a first ISA processor or core to execute the first ISA binary code 806.

References to “one example,” “an example,” “one embodiment,” “an embodiment,” etc., indicate that the example or embodiment described may include a particular feature, structure, or characteristic, but every example or embodiment may not necessarily include the particular feature, structure, or characteristic. Moreover, such phrases do not necessarily refer to the same example or embodiment. Further, when a particular feature, structure, or characteristic is described in connection with an example or embodiment, it is submitted that it is within the knowledge of one skilled in the art to affect such feature, structure, or characteristic in connection with other examples or embodiments whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C). As used in this specification and the claims and unless otherwise specified, the use of the ordinal adjectives “first,” “second,” “third,” etc. to describe an element merely indicates that a particular instance of an element or different instances of like elements are being referred to and is not intended to imply that the elements so described must be in a particular sequence, either temporally, spatially, in ranking, or in any other manner. Also, as used in descriptions of embodiments, a “/” character between terms may mean that what is described may include or be implemented using, with, and/or according to the first term and/or the second term (and/or any other additional terms).

Also, the terms “bit,” “flag,” “field,” “entry,” “indicator,” etc., may be used to describe any type or content of a storage location in a register, table, database, or other data structure, whether implemented in hardware or software, but are not meant to limit embodiments to any particular type of storage location or number of bits or other elements within any particular storage location. For example, the term “bit” may be used to refer to a bit position within a register and/or data stored or to be stored in that bit position. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments to any particular logical convention, as any logical convention may be used within embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
micro-operation (uop) fusion circuitry to analyze a line of uops to find a producer uop and a consumer uop meeting fusibility criteria and to morph the consumer uop into a fused uop, wherein the line of uops includes a number of uops corresponding to a maximum number of uops that can be allocated in a single cycle;
dead producer elimination (DPE) circuitry to determine that DPE conditions are satisfied; and
an arithmetic-logic unit (ALU) to execute the fused uop without the producer uop having been executed.

2. The apparatus of claim 1, further comprising a reorder buffer (ROB) in which a ROB entry is allocated for the producer uop.

3. The apparatus of claim 2, wherein the DPE circuitry is also to indicate, in the ROB entry, that the producer uop is ready for retirement.

4. The apparatus of claim 1, further comprising a reservation station to schedule the fused uop without scheduling the producer uop.

5. The apparatus of claim 1, further comprising retirement circuitry to retire the producer uop and the fused uop together.

6. The apparatus of claim 5, wherein the producer uop and the fused uop are in a group of uops to be retired atomically and wherein in response to a fault occurring within the group of uops, the retirement circuitry is to wait until the producer uop is next to retire, generate a pipeline clear, and disable the DPE circuitry.

7. The apparatus of claim 1, wherein the DPE conditions include that the consumer uop has no destination or that the consumer uop writes to a same register as the producer uop.

8. The apparatus of claim 1, wherein the DPE conditions include that the consumer uop is the only consumer of a result of the producer uop.

9. A method comprising:
analyzing a line of uops to find a producer uop and a consumer uop meeting fusibility criteria, wherein the line of uops includes a number of uops corresponding to maximum number of uops that can be allocated in a single cycle;
morphing the consumer uop into a fused uop;
determining that dead producer elimination (DPE) conditions are met; and
executing the fused uop without the producer uop having been executed.

10. The method of claim 9, further comprising allocating a reorder buffer (ROB) entry for the producer uop.

11. The method of claim 10, further comprising indicating, in the ROB entry, that the producer uop is ready for retirement.

12. The method of claim 9, further comprising scheduling the fused uop in a reservation station without scheduling the producer uop.

13. The method of claim 9, further comprising retiring the producer uop and the fused uop together.

14. The method of claim 13, wherein the producer uop and the fused uop are in a group of uops to be retired atomically, the method further comprising, in response to a fault occurring within the group of uops:
waiting until the producer uop is next to retire;
generating a pipeline clear; and
disabling DPE circuitry.

15. The method of claim 9, wherein the DPE conditions include that include that the consumer uop has no destination or that the consumer uop writes to a same register as the producer uop.

16. The method of claim 9, wherein the DPE conditions include that the consumer uop is the only consumer of a result of the producer uop.

17. A non-transitory machine-readable medium storing instructions which, when decoded by a machine, causes the machine to perform a method comprising:
analyzing a line of uops to find a producer uop and a consumer uop meeting fusibility criteria, wherein the line of uops includes a number of uops corresponding to maximum number of uops that can be allocated in a single cycle;
morphing the consumer uop into a fused uop;
determining that dead producer elimination (DPE) conditions are met; and
executing the fused uop without the producer uop having been executed.

18. The non-transitory machine-readable medium of claim 17, wherein the method further comprises:
allocating a reorder buffer (ROB) entry for the producer uop; and
indicating, in the ROB entry, that the producer uop is ready for retirement.

19. The non-transitory machine-readable medium of claim 17, wherein the method further comprises scheduling the fused uop in a reservation station without scheduling the producer uop.

20. The non-transitory machine-readable medium of claim 17, wherein the method further comprises retiring the producer uop and the fused uop together.
